(19) United States
(12) Patent Application Publication
(10) Pub. No.: US 2018/0241864 A1
(43) Pub. Date: Aug. 23, 2018

(54) Wearable Devices

(71) Applicant: Xovia Limited, London (GB)

(72) Inventors: Benjamin Ian Males, South Croydon (GB); Nancy Alice Tilbury, London (GB)

(21) Appl. No.: 15/741,342

(22) PCT Filed: Jul. 4, 2016
(86) PCT No.: PCT/EP2016/065732

§ 371 Date: Jan. 2, 2018

(30) Foreign Application Priority Data
Jul. 2, 2015 (GB) 1511633.8

(51) Int. Cl. H04M 1/725; H04W 4/12; H04L 29/08; H04W 4/021; H04B 1/3827; H04B 17/27

(52) U.S. Cl. CPC H04M 1/7253; H04W 4/12; H04L 67/22; H04W 4/021; H04W 4/023; H04B 1/385; H04B 17/27; H04M 1/72569; H04L 67/306

(57) ABSTRACT

A system for communicating messages between wearable technology devices, specifically electro dermal sensing wristbands, display apparel and accessories and non display apparel and accessories, in various arenas of use comprising hardware and software to enable devices to communicate with physical and remote servers in order to transfer data and instructions that are related to a specific user and their situation, for example their location or a particular activity. A cloud architecture based on a remote server with at least one user account that holds personal information and preferences related to a user that is also able to evaluate a response based in inputted data. A mobile application that allows a user to interface with the cloud directly.

### FIELD OF THE INVENTION

This invention relates to a system for communicating messages between wearable devices and a plurality of other devices capable of receiving, processing and transmitting digital messages; a system for the automatic switching between operational modes for interactive garments and accessories such as apparel with integrated displays, accessories and others in relation to their immediate arena of use; a method for sending instructions to change outputs in interactive garments and accessories such as the colour and pattern displayed by apparel with integrated displays, a physical and remote server architecture (cloud) for the collection, storage, processing and use (exploitation) of data from the body and environment (arena of use) which allows access to data; A software application (app) to allow a user to interface with the cloud and/or interactive apparel.

The invention also relates to the communication of data in the physical and digital domains where messages containing data and instructions can be sent between devices within the physical constraints of a space but also beyond it by utilising remote services and storage accessible through the Internet. The later part of the invention enables live events to take place at multiple geographic locations at the same time but also enables coordination between events held at different times. The communication element of the invention includes a number of opportunities for determining the location of audience members that can be further exploited for the purpose for which the invention has been adopted.

A preferred embodiment of this invention relates to apparel and accessories that have a visual display integrated into them, in which the display can show content that is stored on a local memory storage device. In this particular embodiment the content stored on the memory can be updated remotely through a wireless communication method such as WiFi or Bluetooth and the content shown on the display integrated into the apparel can be triggered by a smart device such as a smartphone, with said device sending messages which contain instructions that are used by the controller in the apparel to select content and set any additional variables (such as speed or colour) before displaying content on the display. In this preferred embodiment the user has use of a mobile application that allows them to control the apparel but in a slight modification of this embodiment the apparel is controlled by a messages from a radio transmitter in an arena such as a stadium where a musical performance is taking place. In this case the user's apparel (and any other similar apparel in range of the transmitter) will be controlled ‘en-masse’.

### BACKGROUND TO THE INVENTION

Mobile devices such as smart phones, tablets, smart watches and netbooks are used regularly by a significant percentage of the world's population. Such mobile devices can create novel data or use existing data. For example software applications running on mobile devices can use the features of a smartphone to take images and stamp these with metadata including the location and time that the picture was taken. Depending on the capability of the mobile device, other types of data could be collected.

With the rapid growth in the wearable technology and internet of things (IoT) sectors the number of intelligent interactive devices on or around our physical bodies is set to rise and the number of related digital assets will increase proportionately.

Furthermore the popularity of Internet based social networking services such as Facebook, Twitter and Instagram connects textural and visual media assets to a user account. It is common for such services to augment data from other sources such as from a mobile device, for example a Facebook post may include information about a users location.

A user may wish for their mobile or wearable technology (to be referred to from this point onwards as mobile technology) to operate in a specific way when at a specified location such as a music venue and for there to be a link between their physical activities or biometric data and their social media activity. Another example is an automatic notification on an individual's social media channel if a pre-defined criteria has been met, for example a user is standing next to another user that is in their social media friend group or the excitement level measured by a physiological data gathering wristband can determine the design of an avatar to be attached to messages on a social media platform.

The term “arena” is used to refer to the location where any event or type of event takes place. Following are descriptions of the arenas described in this document.

The personal arena is defined here as the locations where a person is not in another specific arena. A person may be in a personal arena at their home or in a place that is not otherwise considered for one of the uses described below. Personal arenas may include but are not limited to: home, office, car, street, etc.

The retail arena is where a service provider services the needs of a large number of individuals, such as members of the public. Retail arenas can include but are not limited to shop windows, stalls, shops, shopping malls department stores and can also include sites where promotions may occur such as billboards and others.

The entertainment arena is where a performance or spectacle such as sport may take place. Entertainment arenas can include but are not limited to: artistic performances of any type (dance, orchestra, band, pop artist etc,), spectator sports of any type, sporting activities, etc.

The social arena is where a number of people may meet (both physically and virtually) to enjoy each other's company and/or interact with each other. Social arenas may include but are not limited to: restaurants, pubs, bars and clubs, chat rooms, instant messaging, Skype, virtual worlds, gaming etc.

The recent popularity of wearable technology and the increasing numbers and ranges of devices available offer an opportunity for the engagement of audiences at different moments and scenarios as defined by the arena of use. The nature of the engagement will depend on factors such as location, time and date and emotional sensing but will also depend on current activity, personal preferences and the digital content available.

An audience is a group of people who encounter a work of art, literature, theatre, music or academics in any medium. Audience members participate in different ways in different kinds of art depending on the conditions of the performance.

An immediate audience is one that is composed of individuals who are face-to-face subjects with a performer and their rhetorical content. For the purpose of this document an audience can be physical, distributed or virtual and a performer is defined as the focal aspect of a performance and could be a music artist, sports team, film or other. An immediate audience directly listens to, engage with, and consumes the rhetorical content of a performer in an unmediated fashion.

Currently the only way of measuring immediate audience reception and feedback is by carrying out personal interviews, measuring the applause or verbal and written comments made during and after rhetorical content is delivered. The consequence of this is that any modification to the performance to take into consideration audience reception is difficult and delayed relative to the progression of the performance.

There have been a number of innovations around crowd interaction such as LED wristbands and merchandise however there has not been a device designed for live events that can read immediate audience reception to enable aspects of the performance to be altered in response. Further to this there is no device or system that allows data gathered from an event to be shared with one or more geographically remote events which may or may not be happening simultaneously and even further to this no invention exists which allows such data to be accessed after an event.

In terms of sensing devices and there are a number of wrist worn bio-sensors available however their focus is primarily heath and wellbeing and non of these are designed to be used in a crowd at a live event or with a de-localised audience such as those engaging through social media or television, they are very much designed to be used on a smaller or individual scale.

There is currently no system for storing data obtained from wearable devices via a wireless or wired transmission method and allowing 3rd parties access to that data in real time and at a different location, to exploit during or after a performance.

Further to the specific scenario of an audience at a live performance there is general interest in being able to measure physiological data from the body, processing this data and relaying to a database for further exploitation. There have been some prior innovations around wireless sensing that use radio protocols such as Bluetooth or Zigbee however they rely on the receiver hardware being present and connected to a receiving device. There are currently no solutions for the measurement, processing and exploitation of physiological sensor data for large audiences (both immediate and remote).

A number of innovations in wearable display technology will allow a deeper interaction with users and audiences. Visual display, haptic outputs and robotic textiles integrated into wearable technology garments will be controlled locally but also remotely through wireless networks. This control may be through a mobile communications device such as a smart phone but could also be through any mobile computing platform including a transceiver ‘beacon’ in an arena of use.

Wearable technology devices such as wristbands that use sensors to measure physiological readings from a user's body such as Electro dermal Response (EDR) and other metrics such as movement and temperature will further add to the possibilities for engagement. Cloud computing platforms will allow users to access services and digital assets for their wearable devices and garments either directly or though a computing device connected to the Internet or a private network. Various methods of direct control can include broadcasting devices installed in various arenas or use or even from a remote source such as a remote server that is part of a cloud-computing platform. A number smart watches, glasses and other personal devices are already on the market and offer further interaction with an audience.

With the popularity of wearable technology there will be an increase in the number of devices and apparel that have integrated (flexible) LED display, Organic LED (OLED), physiological sensing, robotic textiles and surfaces (fit and form) all enabled by advances in plastic electronics, epidermal technologies and material science.

With so many possibilities for interactions there is a need for a combination of hardware and software innovations to allow for enabled apparel to be able to switch between modes and allow their users the full potential of their products. Being able to switch modes and change the operational settings of enabled apparel in specific arenas of use will allow the owners of digital assets and the operators of wireless networks to create tailored experiences for targeted audiences and consequently allow users to experience seamless transition between arenas of use.

The simplest example of a problem that can be solved by this innovation would be a display garment such as a fiber optic dress. The dress has a controller that has the ability to light the fibers any colour with an LED. The user may wish to change the colour of the dress to match a specific colour or animate a pattern and to control this from a smart phone. Further to this the user would like the dress to react to external trigger such as a notification from a social media platform (a new message has been received for example). There is need for software inventions to allow the user to accurately control the fiber optic dress.

Another example of a problem that could be solved by this innovation would be the control of an LED display garment such as a baseball cap. The user may wish for the cap to animate a pattern when they are engaging in normal everyday activities (personal arena). This particular user has purchased a ticket for a concert by a musical artist and would also like the cap to animate during the performance (entertainment arena) with specially designed content that can be synchronised to the visual and audio elements of the performance. There are a number of ways of controlling hardware in a concert environment such as radio frequency (RF), near field communication (NFC) and infra-red (IR) however these technologies are specially designed for applications where there are a large number of devices to be controlled and require specific equipment in the arena of use. The method of communicating to a wearable technology garment or accessory away from a concert environment is very different to those described above as there is no guarantee of the specific hardware necessary being present. A well-documented method of controlling wearable technology is through a wireless connection with a smart phone, computer or wireless network. Examples of protocols commonly used in this type of wireless communication are Bluetooth and WiFi, neither of which is appropriate for applications where a larger number of devices are being controlled. There is a need here for specific hardware to be incorporated into the wearable devices and apparel and for the method of communication to be switched depending on the arena of use and other factors such as the preferences set by the user.

To further describe the problem a scenario involving a fashion retail chain will be used: A user has a pair of sneakers with an Organic LED (OLED) display in the tongue. A controller built into the circuitry connected to the display is able to connect to a smartphone device via Bluetooth. The wireless connection allows digital visual content to be uploaded to the flash memory on the display controller and also trigger this, for example to the beat of the music being played on the smartphone. The fashion retail chain or store, as it will be referred to, has custom digital assets for wearable display garments that are designed to play along side the music in the store. There needs to be a method my which the sneakers know to receive new content from the store through the radio network and instructions on how to animate therefore an innovation is required in both the control hardware in the sneaker and hardware in the store. There is also need for a network that allows the sneakers and the store to know that the user has set their preferences to receive content and control signals from the store.

A further development of the above scenario involves the user wanting to display visual content from a third party web based resource such as Instagram. The controller connected to the display described previously connects wirelessly to a smartphone and an app running on the phone pushes content to it, accessing the content from the 3^{rd} party resource by utilising it's Auxiliary Program Interface (API). However further to this, the user may wish to set preferences to allow for the customisation of the display, for example establishing relationships between certain locations and metadata connected to the visual content. In this case there needs to be a way of calling preference data and ensuring that the correct content is delivered to the sneakers.

Another problem is faced when considering a set of headphones that have visual display capabilities. The user wishes for the display on the surface of the headphones to animate to the beat of the music playing. The controller on the headphones will be able to orchestrate this to some degree by analysing the signal from the music however the design of the animation must be set and this may be different for every song. In this case there needs to be a method by which the correct animations can be delivered to the headphone controller.

A Further scenario uses the example of the wristband able to measure EDR described previously. The bands are being used to measure the emotional reaction of a crowd. The organisers of the performance wish to engage the audience before the event and so a unique username and password is distributed to individuals at the point of purchase of tickets. Users are able to log in to a web page and add information such as identification and preferences. When they arrive at the event they are given a wristband that can read their emotional response through EDR. During the performance data is collected from the wristbands and transmitted to a server in the arena of use and subsequently to a remote server where data from the event is processed and individual data stored, connected to the users' accounts. During the performance messages can be send to the user through a plurality of methods such as email, text message, twitter or any other digital communication method. After the performance the user can look at their data stream and inspect the high and low points during the performance. Further to this the performance operators can control the wristbands depending on the preferences set by the user before the performance, for example the users' favourite colours can be displayed on an LED built into the wristband and the colours change depending on the emotional level of the wearer.

A final scenario can be described when considering an app that is able to send a user messages based on their emotional state. The user is wearing a bracelet that is able to read electro dermal activity (EDA) and send this data to a remote server either directly or by using the wireless connectivity of a linked mobile device. A 3^{rd} party app would like to access information about the user's emotional state in order to construct a message with the appropriate content and for it to be sent at the correct time. There needs to be a way in which a 3^{rd} party app can have access to raw or processed data and the user must be able to set preference to control the type of data available.

### SUMMARY OF INVENTION

There are several parts to this invention that allow wearable technology devices to be able to communicate data in various arenas of use; to control these devices and the flow of data to and from them; to manage and process data and digital assets and to allow access to data, digital assets and instructions/settings, as described in the background section.

### Wearable Technology Controller Architecture

A number of methods have been described for controlling wearable technology in deferent arenas of use. Due to the wearable nature of the devices and apparel in question, all are wireless communication methods such as Bluetooth, WiFi, ultra sound, Infra red (IR) and others. In order to be able to receive and communicate in a range of different arenas of use, it will be clear to an expert in the art that the controller architecture for apparel and devices must include a range of wireless communication methods. Further to this, the methods of communication must be orchestrated in such a way, so as to maximize the efficiency of the system while maintaining functionality. Any utilization of unsuitable methods in a particular arena will result in greatly reduced battery life but may also cause unnecessary communication interference in the arena of use (both a electrical power efficiency and one of successful communication).

The controller will include but is not limited to a microcontroller, Bluetooth circuitry, radio transceiver, Wifi and an Infra-red (or visible) light receiver with a suitable lens to ensure that an incident light source carrying pulsed information is focussed on the light sensitive surface. Any or all of these elements can be positioned away from the main body of the controller to enable that element to be in the optimum position to receive and transmit data (for example IR must have line of site to ‘see’ a transmitter.

Further to this apparel and accessories may use the presence of other enabled apparel and accessories to act as relays for communication thereby maximizing the communication capability in addition to allowing second order information to be inferred such as location.

The controller may include circuitry which allows the voltage of the battery to be determined and thereby the battery life to be estimated. When the remaining battery life falls below a determined level then the firmware running on the microcontroller in the controller can put the device into a low power mode. In a low power mode the device acts as an iBeacon. Only the Bluetooth is enabled and a message is broadcast to any listening devices. This message can contain a special code and the listening device can measure Received Signal Strength Indication (RSSI) which can be used to determine approximate distance. A message can relayed to a user through the user interface of an app running on a smartphone, for example it could say “Your device is nearby and is out of charge . . . please charge it”

In the specific example of measuring audience reception to a performance, there are a number of technological solutions: A user interface such as button can be pressed during a performance to give feedback however this is not automatic and therefore not a good representation of immediate response. Another more effective way to measure audience reception is to measure the physiological and physical reaction to a performance. The arousal experienced by a person can be evaluated by observing changes in physiological readings from the body. Physiological markers of the body can include, but are not limited to Electro-dermal response (EDR), Electroencephalography (EEG), skin temperature, heart rate and pulse oximetry.

Embodiments of this part of the invention focus primarily, but not exclusively on Electro-dermal response (EDR) which is the change in the electrical conductance of the skin. Skin conductance varies depending on the moisture of the skin, caused by sweat. Sweat is partially controlled by the sympathetic nervous system therefore skin conductance is used as an indication of psychological or physiological arousal.

Sensor data from the individuals in an audience can be measured in real time and transmitted wirelessly to a transceiver unit after which the data can be processed and used to control aspects of the performance such as lighting, sound, visual and other stage effects. In addition, instructions can be sent to the device to change the nature of the outputs on a wearable device in the form of lights or uniquely, haptic feedback (vibration) or other. This communication can be to individual devices or globally to all devices, hereby enabling two-way communication between the audience and the artist/performance and an immediate measurement of audience reception. Further to this communication can occur between the individual devices, which can allow messages to propagate through a crowd or between a selected group of audience members.

Bluetooth technology is widely used in wearable electrical devices as a wireless communication method however it has limitations when a large number of devices are in the same location. If the audience is not in the same place: if they are at home and engaging a performance through television or the internet for example, then Bluetooth can be used to wirelessly connect a sensing device to a smartphone, tablet computer, Bluetooth hub or other Bluetooth enabled device. A departure from this is iBeacon technology where messages containing ID and RSSI information are broadcast to any listening device.

The inclusion of wireless technologies such as Bluetooth into sensor devices can add to the component cost considerably. In addition, mobile sensing devices such as wrist worn EDR sensors require power in the form of batteries. It is possible to provide a small amount of electrical power to a sensing device through the audio jack of a computing device. By enabling a low energy microcontroller to power up though this method a sensor can be read and the data communicated back to the computing device through one or more of the available audio channels though a 3.5 mm jack for example. An app running on the computing device can control the output and input of the audio (due to the inclusion of an input channel for the microphone) and thus power and listen for an encoded message containing the sensor data. In this way a low cost device can be designed that requires no battery or wireless technology.

In the case of a live performance, data received from wearable devices can be fed into a server computer where it can be stored and processed in order to generate instructions for external hardware or other outputs. In the case of an alternative audience who are not all in the same location, the data from the wearable device can be transmitted by a mobile computing device, or other, to a cloud computing architecture where it can be stored, processed and exploited with an app on the mobile device being the most likely method of interface for the user and wearable device. Further to this the data received from wearable devices in a live performance can be collected by a server and then transmitted to a second server over the Internet where it can be accessed from any device that has a connection to the second, remote server. The ability to transport data in this way enables the system to connect events at geographically separate locations. By way of the remote server described in the previous example, an audience member can register pre-event. By inputting information about the device such as the unique identification of the hardware, it is possible for an event organiser to engage the audience member before a performance. In addition, by registering details such as the members identity, pictures or other digital assets such as a message or avatar, the event organisers can connect the live data gathered from the devices during the show to the details outlined and thereby create an even more unique experience for an audience member.

The inclusion of physiological sensors into a battery powered wearable device enables readings to be taken from the body. By including transceiver circuitry in the device design, physiological signals from the body can be transmitted to a one or more transceiver devices placed in the arena of use. Being also able to receive data, the wearable devices can also be sent information from the area transceivers such as commands that can alter the state of an output such as an LED or vibrator. Further to this the transceiver circuitry allows messages to be sent between devices. If information about relative location in a message sent between devices, by including a received signal strength indicator (RSSI) for example, it is possible to propagate a message through a crowd where part of such a message is an instruction to pass the message on to devices that are within a certain range. The outcome of such a protocol will be an annular propagation of the message through a crowd. If the message is modified at each step and a time-code added which gives information about the time taken for a message to reach a particular device, then it will be clear to an expert of the art that the distance from the first message could be determined. Further to this if 3 messages were sent from known locations in a space then the relative location of a device in that space could be determined.

By evaluating the excitement levels of an audience a performance can be linked directly to the viewer, thereby increasing the inclusion of audience members into the ebb and flow of the performance and representing changes in audience response in real time through a number of mediums including lighting, sound, special effects and many more.

A unique identifier in each wearable device enables the data stream from each device to be isolated and stored on a database on a sever device. It is preferable that the data is then transmitted to a remote server where it can be processed by a software application that can access other devices in the same way or other services such as social media channels.

Preferably the visual or haptic output on the wearable device will allow the designers of a performance to communicate directly with the audience individually or as a group. By controlling the colour and animation of an LED or vibrator in the device, in-crowd effects can be achieved. An example of an in-crowd effect could be that the LED flashes with the beat of the music or the colour of the LED represents the data readings from one of the physiological sensors, such as EDR.

Preferably a program on the server device will process the data in the database and use it to control variables in the performance such as the lighting, sounds, special effects or other.

### Arena Beacons

In order to communicate with wearable technology apparel, accessories and devices in a particular arena of use there is a need for messages to be communicated wirelessly. These messages can contain data as in the example of the EDR wristband described in detail previously, however in other examples these messages may be used to trigger a switch in operational mode. These ‘mode messages’ as they will be known do not contain digital assets such as visual animations, music or other but inform enabled devices that they are inside a particular arena and therefore should change their mode of operation to suit. Messages may also contain: specifications of communication for the enabled apparel, accessories and other performance specific criteria; access credentials for external hardware and software that wishes to use personal data or have control of said enabled apparel and any other information connected to the performance of enabled apparel in a particular arena of use.

### Cloud Architecture

Once wireless communication between the wearable technology apparel, accessories and devices is established then the system will be able to draw on remote information about the user and their relationship to the arena of use. In the example of the LED baseball cap, the user would be able to log on to an online membership account where they set the preferences for their experience of the performance to allow the artist wireless access to the baseball cap. Once the user data has been received the user preferences can be checked and the relevant instructions sent to the apparel and accessories to allow for integration into the arena of use. If the user has not set preferences for the arena then a message will be pushed to the connected smart device to prompt action such as signing up to services. This could also be done directly in the arena of use. Other data stored and managed by the cloud include locational data from GPS and cellular sources, physiological data such as EDR and heart rate, environmental such as temperature and humidity or any other data that can be measured directly or derived from others.

It will be appreciated by an expert in the art when considering the examples given here that by carefully orchestrating the communication between devices in a physical space and subsequently to a remote server which includes a user account with preference settings, data from wearable devices and plurality of other relevant information, that a user wearing connected apparel will be able to experience a unique performance tailored to them. In order to allow further exploitation by 3^{rd} party services and devices an Auxiliary Program Interface is made available. This API will allow secure access (using the industry accepted protocols) to raw and processed data and allow instructions to be posted to the user account which, depending on a multitude of factors which may include preferences set by the user and the presence of specific devices in a particular arena, be used to change the performance of said devices or elements of a performance.

### BRIEF DESCRIPTION OF THE DRAWINGS

An example of the invention will now be described by referring to the accompanying drawings:

FIG. 1 shows a jacket with an integrated display that is paired to a smartphone running an app; is communicating with a cloud and is communicating with an arena beacon.

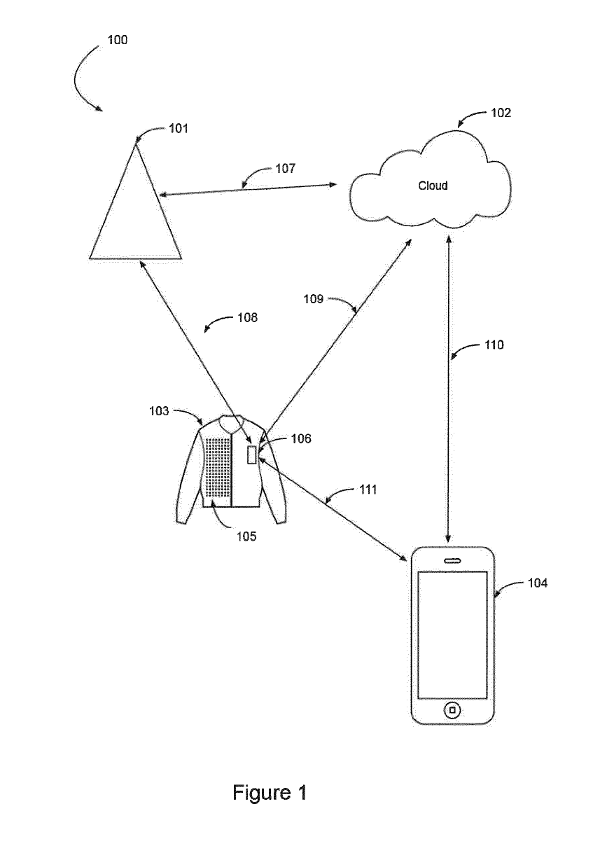

FIG. 2 shows a schematic of a display apparel controller printed circuit board (PCB)

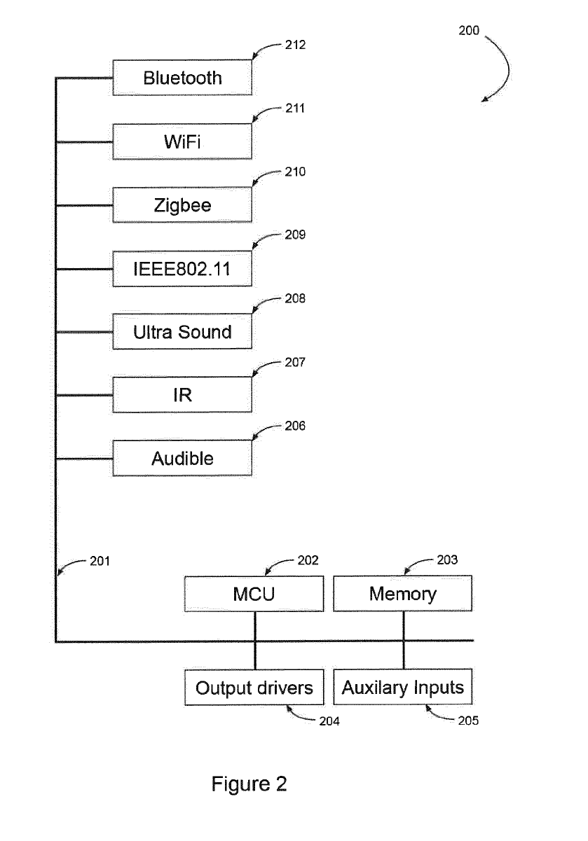

FIG. 3 illustrates the system by which hardware devices typically communicate in the invention.

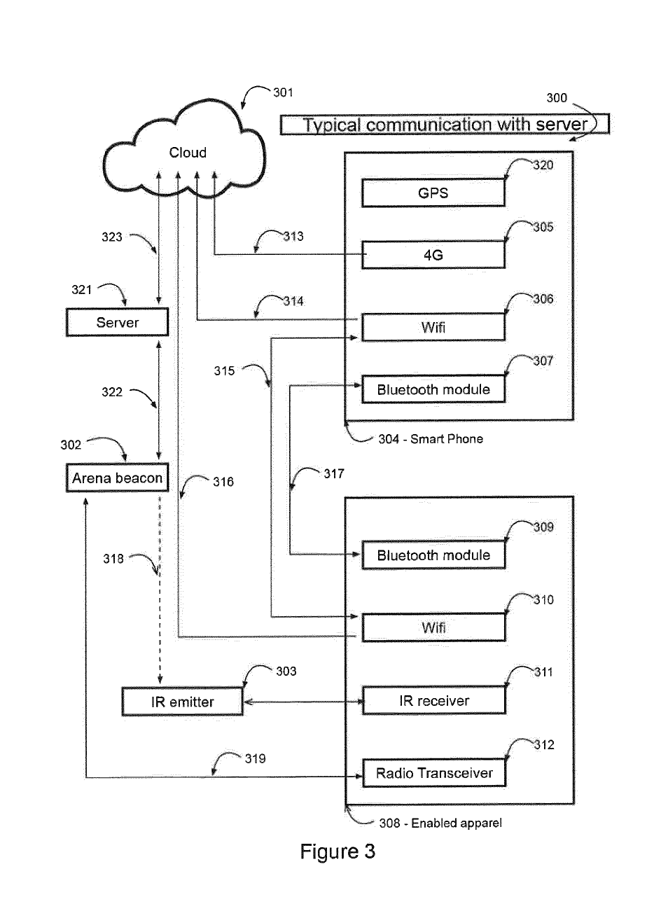

FIG. 4 illustrates the typical structure of the cloud architecture.

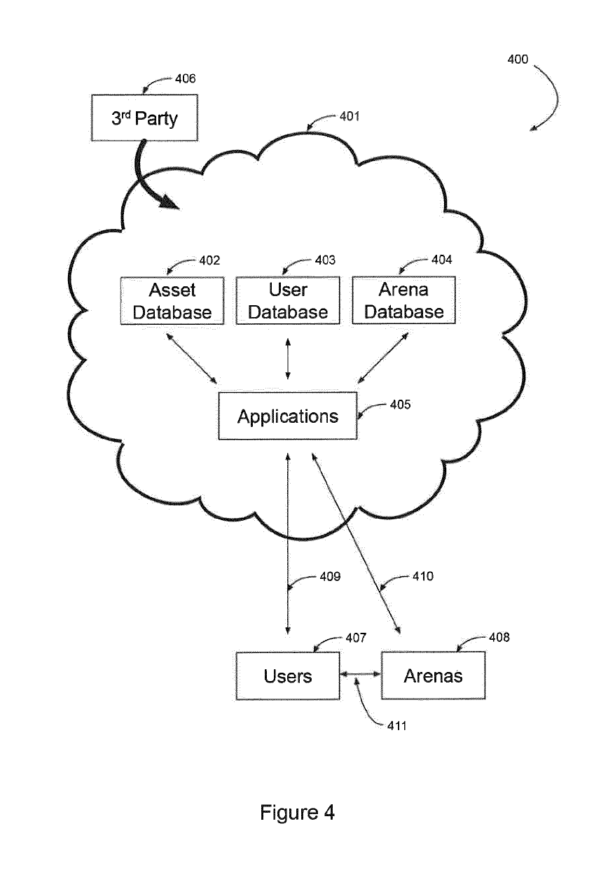

FIG. 5 illustrates the structure of a user account in the cloud architecture

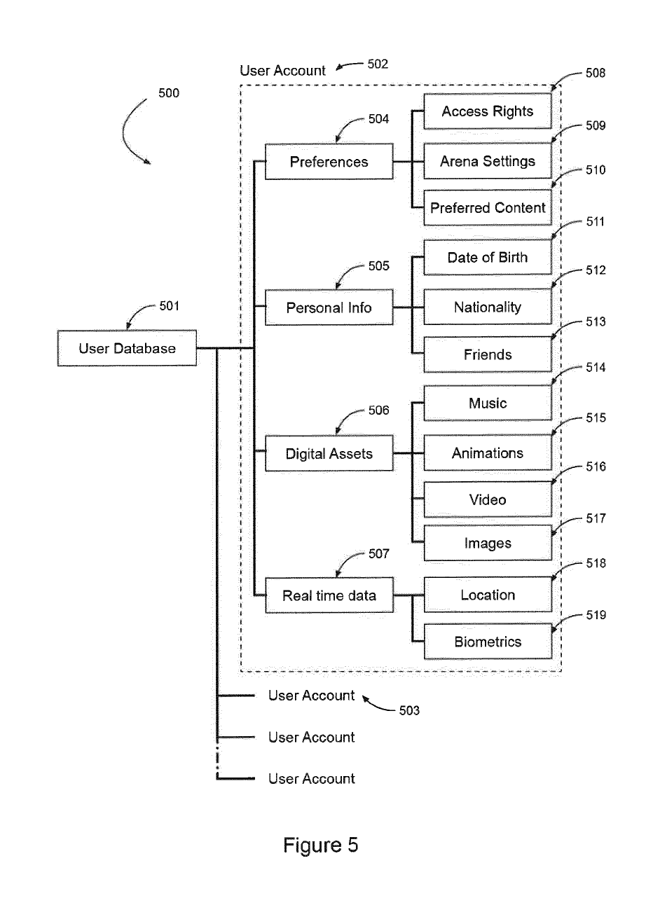

FIG. 6 shows the main screen-view of a typical app

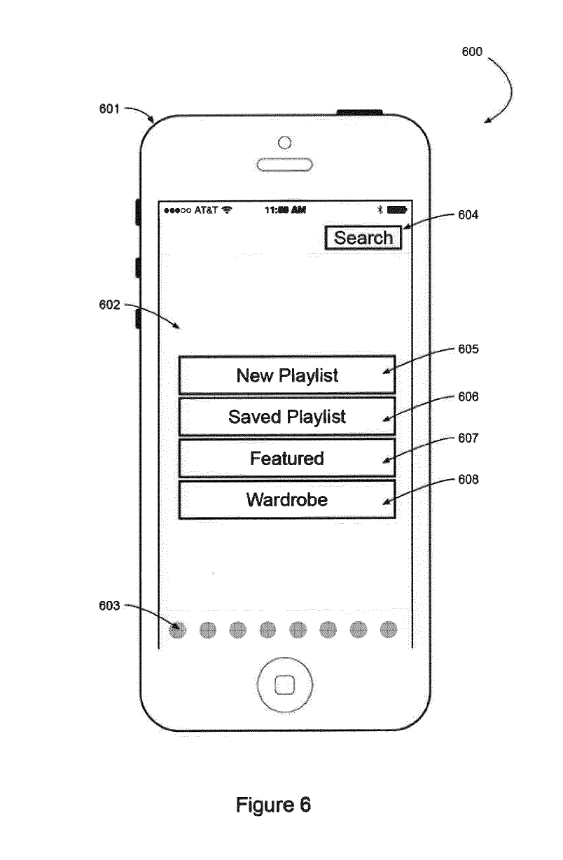

FIG. 7 shows the content generation screen-view of a typical app

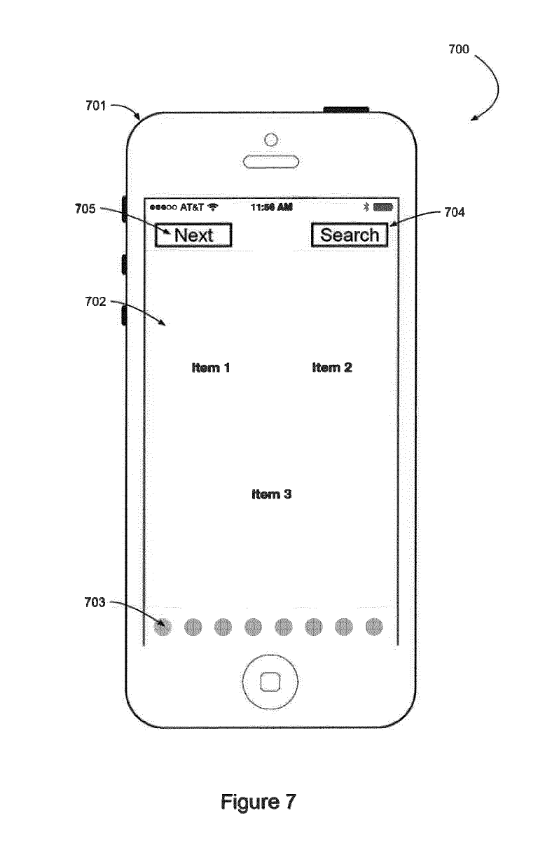

FIG. 8 shows the animation selection screen-view of a typical app

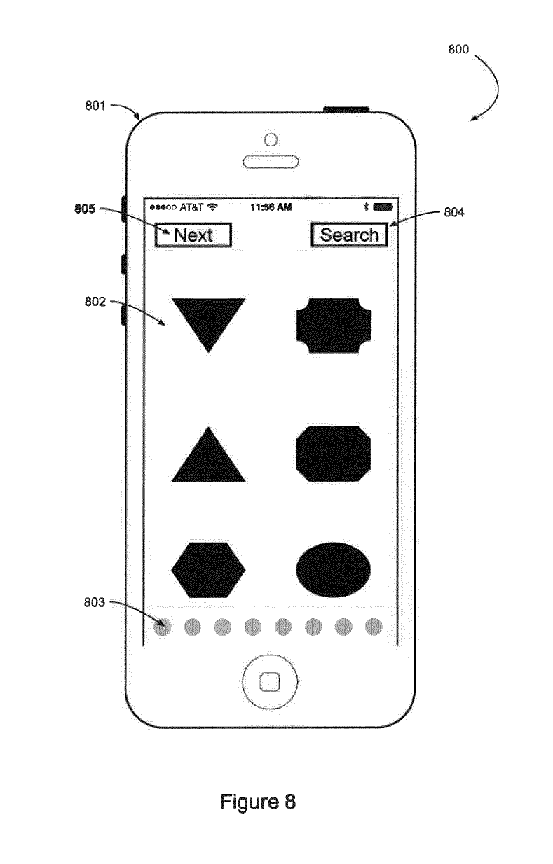

FIG. 9 shows the animation review screen-view of a typical app

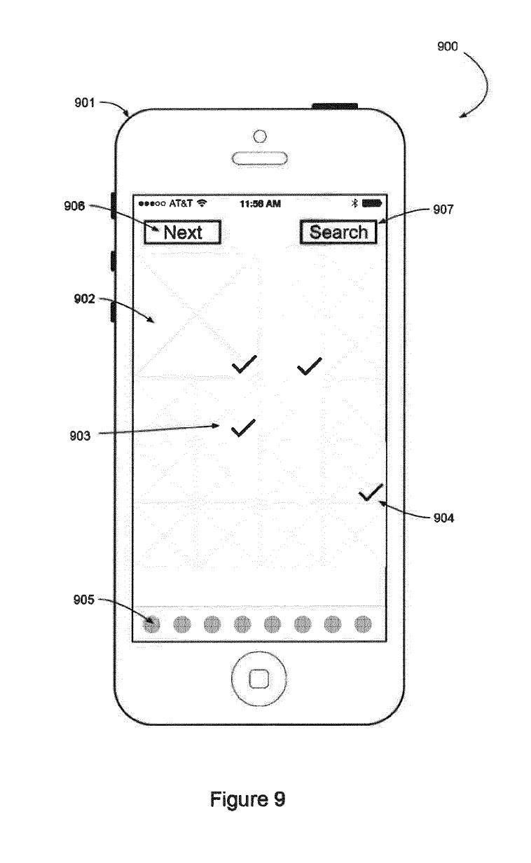

FIG. 10 shows the apparel simulation screen-view of a typical app

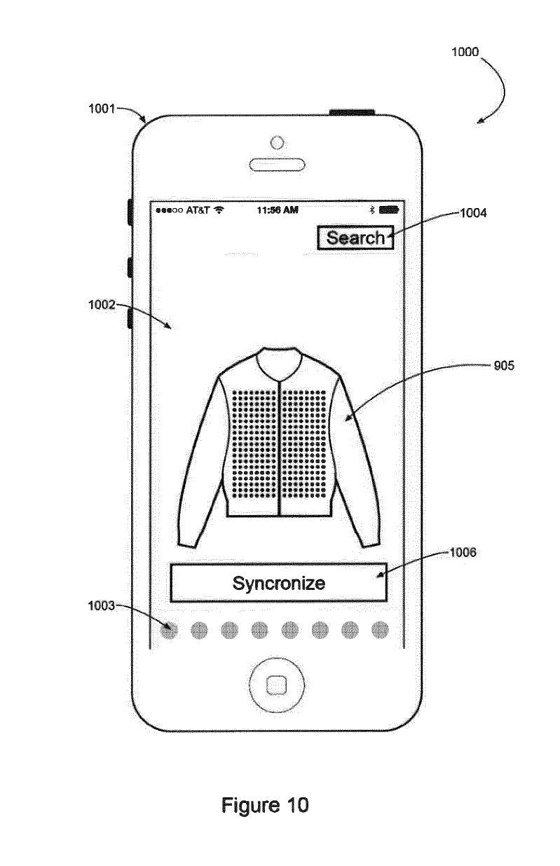

FIG. 11 shows a schematic of an arena beacon printed circuit board

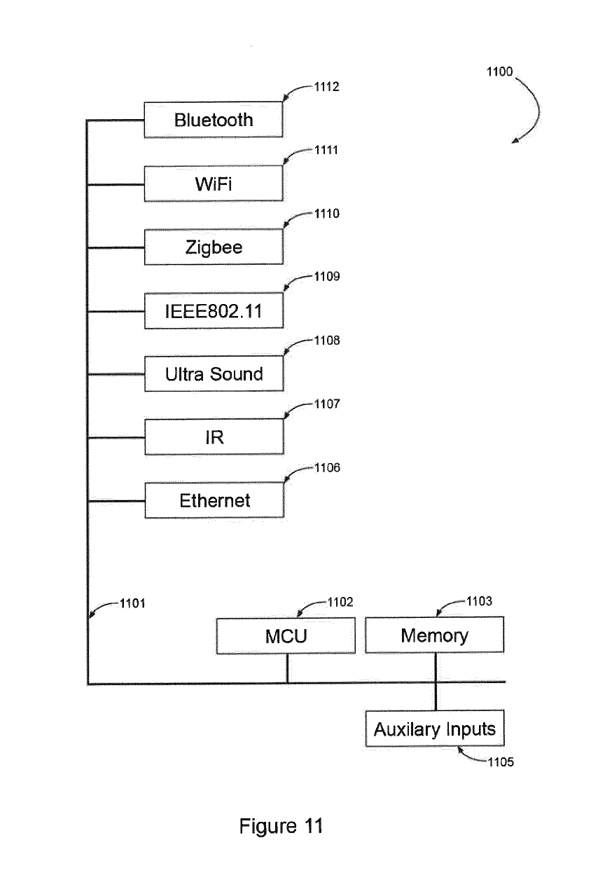

FIG. 12 illustrates an infra-red (IR) pass for the calibration of location information in enabled apparel.

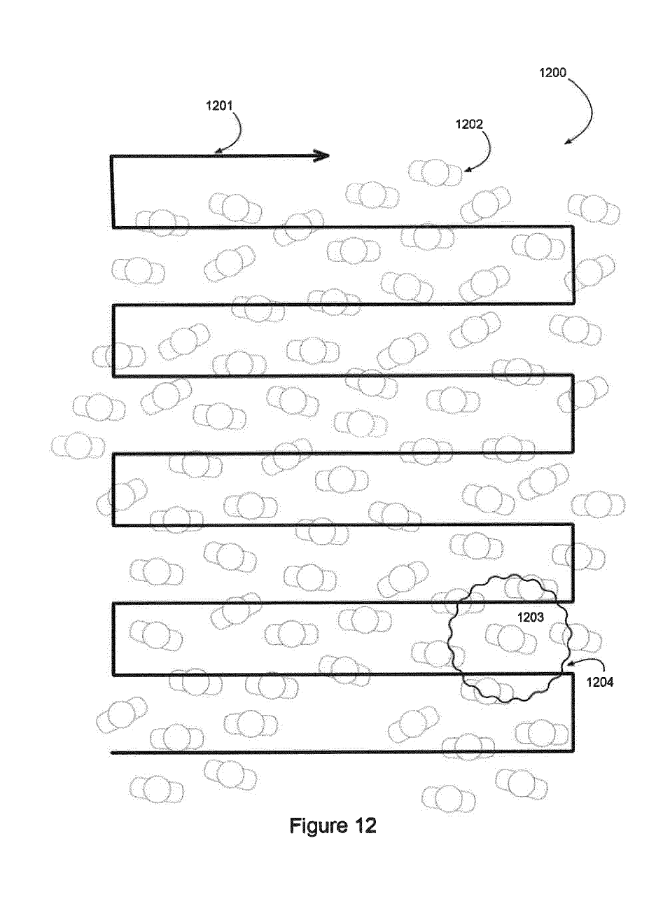

FIG. 13 illustrates the propagation of a message through a crowd in order to calculate location.

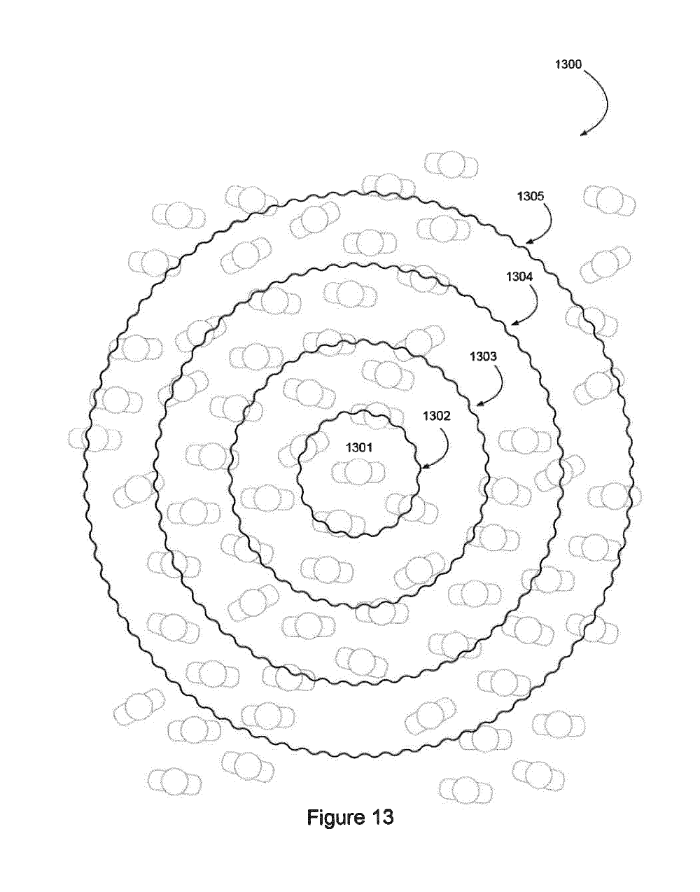

FIG. 14 illustrates the triangulation of distances to locate an individual in a crowd.

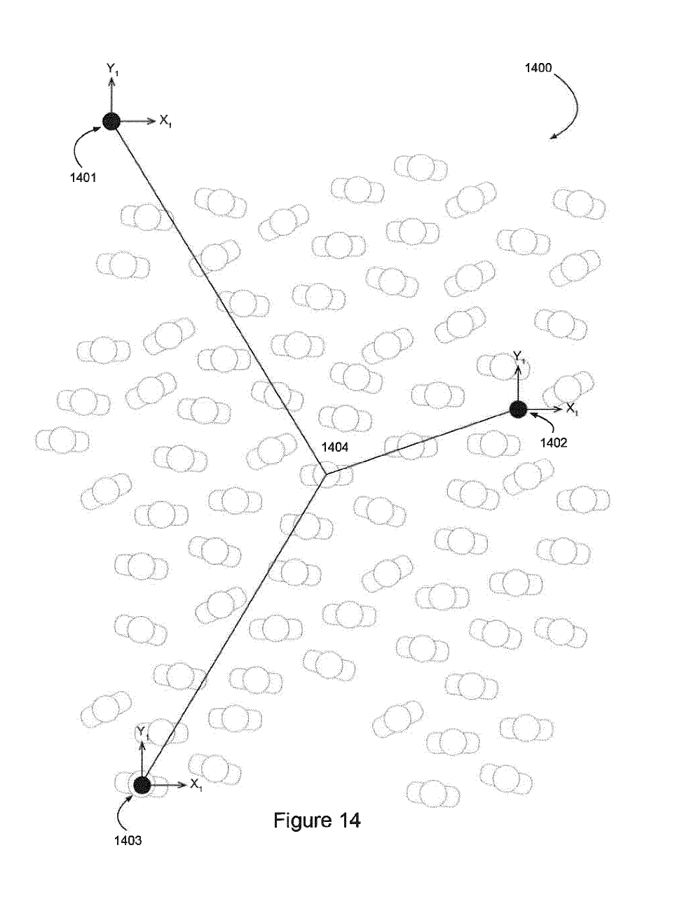

FIG. 15 shows a wristband with the electrodes and the LED display

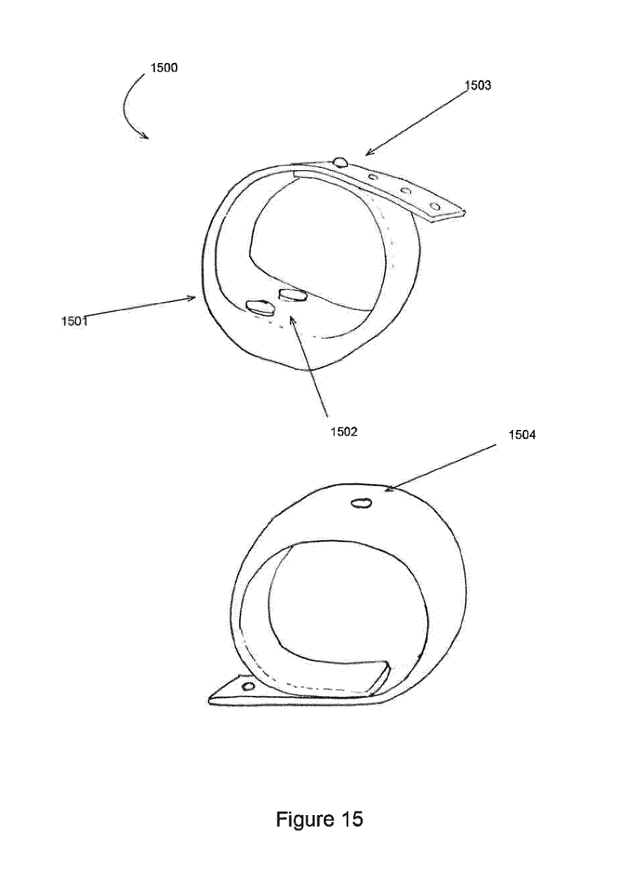

FIG. 16 shows the wristband fitted with the sensor contacts on the inside of the wrist

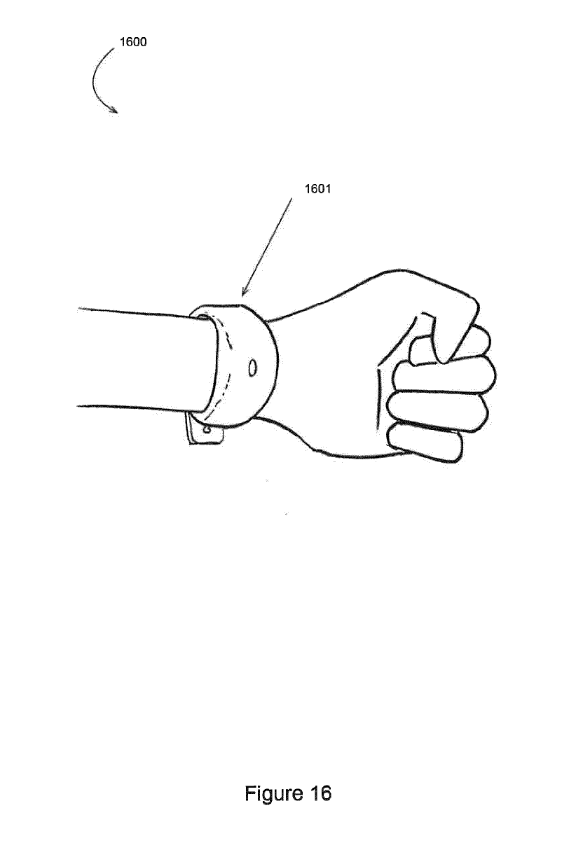

FIG. 17 is a flow chart of the method of operation of a device when operating according to a preferred embodiment of the invention.

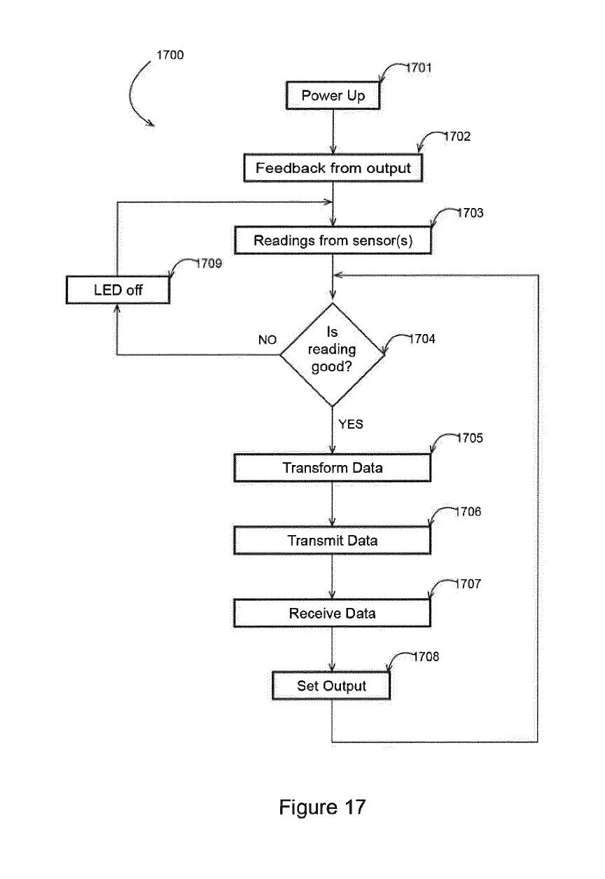

FIG. 18 is a system diagram of a specific embodiment the system when related to collection EDR data

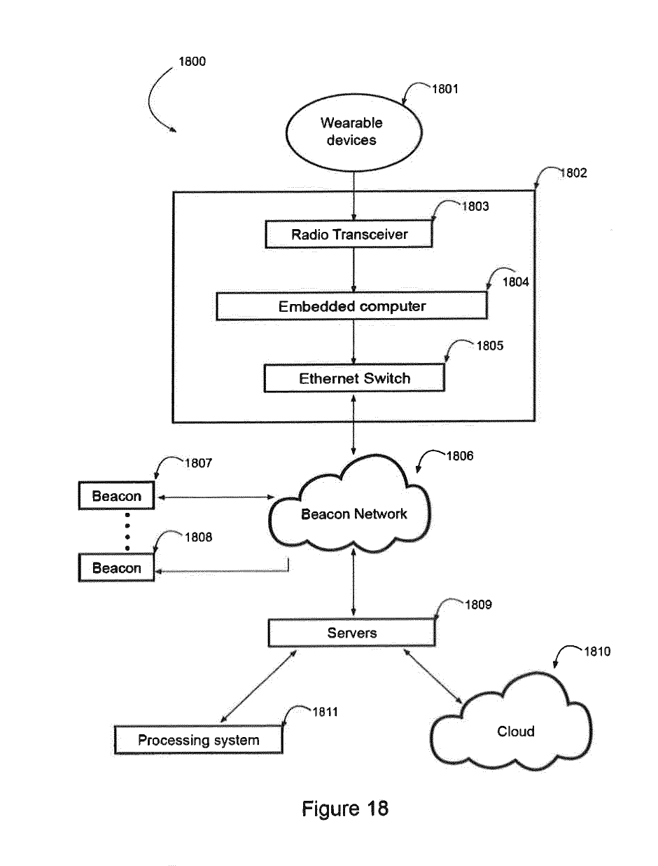

FIG. 19 is a diagram illustrating a typical implementation of the system

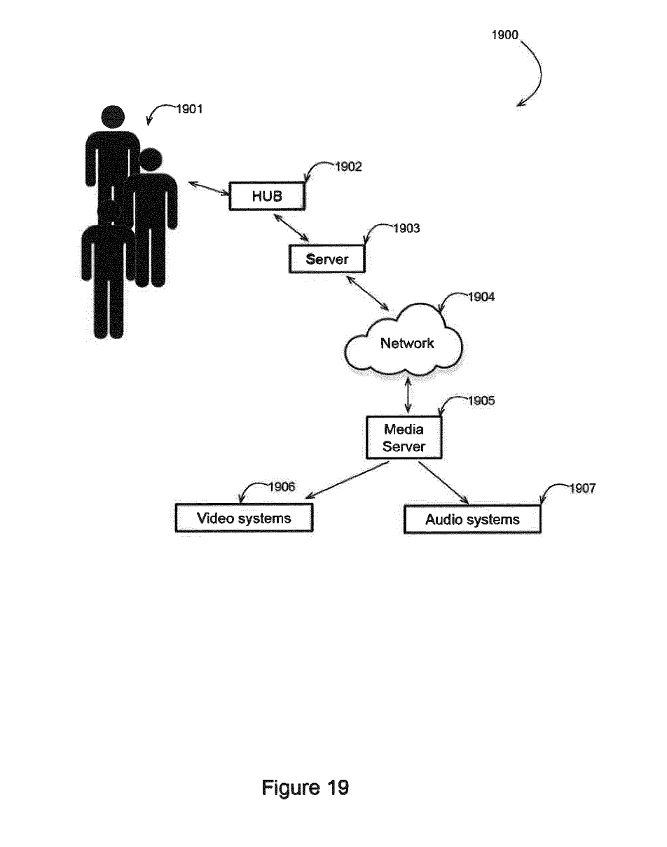

FIG. 20 shows a schematic of the wearable device PCB

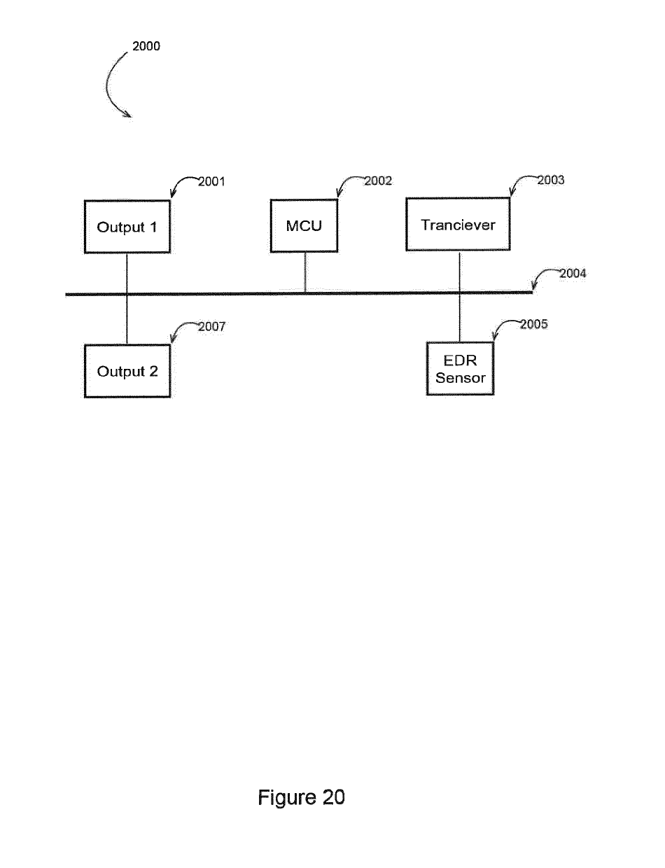

### DETAILED DESCRIPTION

An embodiment of the invention can be described by using the example of a jacket 103 with an integrated display and a haptic module 105 where the jacket 103 and user are situated in the personal arena. Any other type of apparel or accessory could replace the jacket in this embodied example. The controller on the jacket 106 is paired to a smartphone 104 device through Bluetooth and may be able to send and receive data through another wireless method 111. The smartphone is running a mobile application (app) 600 that uses the wireless connectivity of the phone 110 to connect to a cloud architecture (cloud) 102.

The app is able to access a user account 502 and check for preferences set by the user: for example any instructions specific to the arena of use. Depending on the preferences, access may be granted to stored digital assets 506 such as digital content and music. Digital assets are downloaded directly by the controller in the jacket 308, wirelessly connecting with the cloud using a radio protocol such as WiFi 316, and the assets are stored on a local storage device such as flash. It is possible that the jacket in this embodiment does not have access to WiFi and in this case the controller may connect to the cloud by tethering with the smartphone (using the smartphone as a WiFi access point) 315, 313. The app is also able to check for firmware updates for the MCU in the controller. These updates are downloaded by the controller in the jacket and loaded onto the MCU by way of a bootloader program running on the MCU. The controller in the jacket animates the display on the jacket to the beat of the music being listened to by the user.

A display may consist of a matrix of LED modules on a flexible or ridged printed circuit board. The LEDs may be full colour with a red, green and blue LED element in each module and may have additional colours such as white. Alternatively in another embodiment the display could be any number of display technologies including but not limited to TFT, Fibre Optic, OLED, E-ink or projection.

In the case of LED modules each colour is controlled using a pulsed current, the pulse width of which will determine the intensity of light of that specific colour. It is possible therefore to change the colour of the output light of a specific LED module. The LED module is connected to an integrated circuit (IC) or a suitable number of IC's that supply pulse width modulated (PWM) signals to each colour of each LED module. These ICs are called “LED Drivers”. By sending specific instructions to the LED Drivers, patterns can be displayed on the LED matrix. Specific instructions are sent from an MCU built into the controller in the jacket. The LED driver IC may be incorporated into the LED module or be a separate component and mounted on the controller PCB.

In the case of Fibre Optic display, optic fibres may be incorporated into a textile or used as they are; in either case the fibres are grouped together and terminated. In most cases the fibres are held together with a ring of material such as an adhesive tape, heat shrinkable sleeve, or a crimped metal however other methods such as resin or glue can be used. A group of fibres is connected to an LED module as described above which may be full colour with a red, green and blue LED element in each module and may have additional colours such as white. The LED module is positioned in a way that directs the light down the fibres. With internal refraction the light transmitted through the fibres and lights up the textile or group of fibres. The LED can be connected to the fibres by way of a glue or epoxy resin, however in a preferred embodiment the LED is attached with a mechanical fixing. The mechanical fixing could make use of a threaded part on both the fibre and LED sides that hold the terminated fibres and the LED together when screwed tight. An alternative solution would be to use a bayonetted fitting that hold both sides together.

If TFT, OLED, E-ink or another type of display device is used the display described in this embodiment would consist of a display device with a control circuit. The manufacturer of the display device either supplies the control circuit or they specify a design. In some instances the display device can be controlled via a specialised IC that can be incorporated into the control PCB or on a separate driver board. The display driver is able to create visual content on the display device as per instructions sent from the controlling MCU in the controller. Appropriate electrical connections are made between the MCU and display driver circuit following the manufacturer's guidelines and appropriate software code incorporated into the MCU firmware to translate visual content stored on the internal memory of the MCU or an external device also on the PCB.

The controller in the jacket consists of a printed circuit board (PCB) 201 with at least one microcontroller (MCU) 202 and an electronic memory device such as a flash chip 203 however the flash may be incorporated into the MCU. The controller has a number of wireless communication functionalities and may have some or all of Bluetooth (including low power variants) 212, WiFi 211, ZigBee 210, IEEE802.11 209, ultra sound 208, Infrared (IR) 207 or audible sound 206. Some or all of these wireless communication functionalities may be integrated into the MCU or be created with separate electrical componentry however some wireless technologies may be de-localised from the main controller to facilitate their function, for example an IR module may be situated close to the surface of the apparel to ensure line of site to any IR transmitters. The PCB has suitable circuitry to control a display as described previously and may have inputs for other devices 205 such as sensors. The PCB also has suitable circuitry to measure the voltage across the terminals of a battery pack. Suitable circuitry may consist of a simple voltage divider circuit where the output voltage of the divider is evaluated with an Analogue to Digital Converter (ADC). The ADC may be integrated into the MCU but can also be an external device and part of the PCB. The voltage across the terminals of a battery can be used to determine the battery life and therefore once measured by a suitable circuit, as that described here or any other suitable method, then the output data can be used by firmware running on the MCU to determine a suitable mode of operation. In this embodiment it is advantageous for the jacket to be put in a “Low Power Mode” when the battery life is below a certain point. For example when the battery life is below 20% full battery life then the firmware initiates a low power mode. In Low Power Mode the Bluetooth functionality is configured to act as a low power beacon, broadcasting the device ID at regular intervals and all other outputs such as LEDs are disabled. The broadcast message may also include other information such as the state of the controller (i.e. in Low Power Mode). The benefit of this action by the firmware on the MCU is that the power consumption of the jacket is reduced considerably and it's functional life extended. In this example Bluetooth is used however any of the other radio protocols mentioned in this description can also be used. In the low power mode a broadcast message including ID can be received and used by a device such as a smartphone running an app that can then relay information to the user about the state of the jacket. For example when in low power mode the smartphone will prompt the user to charge the battery in the jacket. Furthermore, an evolution of this example, which will be understood by a professional in the field, is that if a Received Signal Strength Indication (RSSI) were also evaluated at the smartphone, then it would be possible to locate the jacket in a space.

In the examples of the LED matrix and fibre optic display, the animation instructions sent from the MCU to the LED Driver are selected from a library of digital content that is stored on the flash chip or integrated memory of the MCU. These instructions can be simple but some are formulated from functions that can have a number of input variables in order to customise the nature of the instruction, based on the digital content, and therefore change the overall appearance of the LED matrix. Input variables may include one or more time constants, colours or any other type of variable. A simple example would be a function that takes red, green and blue values and maps these directly to output PWM levels and thereby changes the colour of the LED module. In another example a function takes a time variable which is used to define a millisecond delay between flashes of the LED module. While there may be a number of instructions on the memory at any one time, they can be updated, removed or completely new instructions added. New instructions or modifications can be uploaded to the controller by a wireless method such as Bluetooth or any of the methods given earlier in this example.

In the example of TFT, OLED or another type of display device being used then the instructions sent from the MCU to the display driver are derived from digital content on the memory. The digital content may be in a file format such as bitmap or any other file type and could be a single frame of content or a series of frames of content for dynamic content. Instructions can be a simple translation of the digital content data or can be formulated from functions that can have a number of input variables in order to customise the nature of the instruction and therefore change the overall appearance of the content on the display. Input variables may include one or more time constants, colours or any other type of variable. A simple example would be a function that takes data from the digital content and maps this directly to the display device. In another example a function takes a time variable which is used to define a millisecond delay between frames of content thereby setting a speed for the dynamic content. While there may be a number of instructions on the memory at any one time, they can be updated, removed or completely new instructions added. New instructions or modifications can be uploaded to the controller by a wireless method such as Bluetooth or any of the methods given earlier in this example.

In addition to a display, the jacket has a haptic actuator such as a single vibration module or multiple vibration modules. A vibration module typically consists of an electric motor with an off-balanced mass on the rotated shaft that imparts force into the supporting feature. In this case the supporting feature could be the controller PCB or a separate assembly. A suitable circuit for controlling the vibration module is included on the controller PCB or is separate with the possibility of it being incorporated into the vibration module itself. A suitable circuit, or vibration module driver circuit, may make use of power amplification electronics using Field Effect Transistors (FETs), purpose made ICs or other and will be controlled by the MCU in the controller. In some cases the vibration module can be controlled with a pulsed current, the pulse of which will determine the intensity of the vibration. The vibration will be controlled by the same instruction as is described for the display control, with the vibration being an artefact in the digital content described previously.

A suitable battery pack provides power to the jacket. The capacity of the battery pack will depend on the power consumption of the LEDs and controller but it is expected that Lithium Polymer or derivative battery chemistry be utilised. The battery is rechargeable and can be charged via a suitable charging circuit that may include a specialised battery charging IC. This circuit may be part of the controller PCB but it may also be separate, for example it may be part of the battery assembly. In a preferred embodiment the battery is charged using inductive charging where an induction coil is used to create an alternating electromagnetic field from within a charging base, and a second induction coil in the jacket takes power from the electromagnetic field and converts it back into electric current which is fed through the charging circuit. The second induction coil described here could either be integrated into the controller PCB, the battery assembly or be separate to both. For example in the specific embodiment of the display jacket described here it may be advantageous for the second coil to be located in a hanging loop on the inside top of the jacket. It would be easy to envisage a charging base design that attached to a hook or hanger and allowed the jacket to be charged while hanging. In further embodiments the second coil is located on an internal or external feature.

The app on the smartphone is able to connect to a cloud architecture hosted on a remote server using the wireless communication capability built into the smartphone 313, 314. These could include 4G, Wifi or other. The app is able to communicate details of the user to the cloud that can then be used to authenticate the user and allow access to their personal information, which could include preferences set by the user. If the user is using the app for the first time then they may be asked to set up a user account where they input personal information such as name and username that is used to set up a user profile. This user profile will follow a standard database format. It is possible that the user already has a user account but is using the app on a new device, for example, and therefore they can input the existing details to access their user account.

The app has a graphical user interface (GUI) 602 that allows the user to navigate through the various functions of the App. One of the options in the App is to change the preferences stored in the cloud 504. Preferences may include favourite animations and effects, music and sound files and the details of other users considered as ‘friends’. Preferences may also contain virtual links between various media and other data metrics such as location, speed of movement and anything else that can be measured directly or deduced from data collected by the smart device and/or any enabled apparel linked to it, for example the speed of a musical track can be changed proportionately to the user's speed of movement.

A cloud architecture 400 exists that consists of a number of software applications 405, at least one database and any other computer related resource. The databases contain personal information and preferences as previously described and may also hold digital assets such as animations, images, video, music and any other data that may be stored on a remote server. While such assets are related to a specific user account and stored in a user database 403, the cloud may also store assets that are not connected to user account 402. A database may exist for arenas that hold information, preferences and assets for spaces and places 404. The cloud has processing capabilities that allow it to use data received from the jacket controller or smartphone 409, or from arenas 410, to make decisions about the preferred configuration of the hardware in the jacket and may also control the configuration of the smartphone hardware. Data such as location and movement messages sent over radio (Bluetooth or other), IR, ultrasound or other; access rights (purchased or other) and any other determinable data are used to ascertain the arena of use and the correct configuration of the hardware. Correct operation may include switching on or disabling communications methods or alternatively prioritising messages from a specific source (wireless or otherwise). For the purpose of this example the user is in personal arena. This is inferred by the cloud through analysis of input data from both the jacket and smartphone and potentially the lack of relevant information from any other arena. The smartphone GPS location service 320 is able to locate the general location of the user and the smartphone can also contribute other information such as the details of any detected Bluetooth iBeacons 101 (which can be used to locate a device inside a building for example), movement, manual settings inputted into the app, music being listened to or even contextual information from text, email or speech (using speech recognition) or any other data that can be measured or calculated. Data from the jacket can include any messages picked up by any one of the wireless methods built into the jacket. It should be easily accepted by the reader that a software application running on the cloud is able to determine the arena in which the user is situated if given adequate access to data.

An app has a GUI 602 that allows a user to configure the behaviour of an enabled garment such as the jacket described in this embodiment. The App is operated by the wearer of the jacket who can use it to create custom content from a range of sources: online music retailers (eg. Spotify, Soundcloud), publishers (eg. Dazed & Confused, iD), Venues (eg. O2, Nightclubs), fashion designers, artists, film, TV and any other source of digital assets. The user selects digital assets and then may apply effects to them to create personalized animations (animations). The effects can include but are not limited to blurring, pixelating or colour substitution. The animation can be synchronized with the jacket and be displayed on it through the LED display. The app works across a range of mobile devices meaning that the user can use a tablet or smartphone to do the more in-depth selection and editing and then use a smart watch or other device to switch between playlists or content whilst on the move.

The first screen-view of the app 600 shows the user the top level options of the app which may include self explanatory buttons such as “New playlist” 605 which is used to generate new playlists, “Saved Playlist” 606 which is where previous playlists are stored, “Featured” 607 which is where the user can find playlists from designers, artists and publishers. Finally there is “Wardrobe” 608 which is where the user can see which apparel is available for connection and upload. In this embodiment “playlist” is used to describe a selection of animations to be outputted on the display jacket.

Throughout the application the user has access to a slide menu 603 which can be located at the bottom of the GUI but could also be positioned anywhere on the screen, and the search function 604 which can be positioned at the top of the GUI but could be anywhere else on the screen or accessible as a completely new screen-view after pressing on a button. These buttons allow easy access to the other features if the app: the slide menu has access to all main features plus: user profiles, notifications and settings.

Pressing on a button such as “New Playlist” 605 takes the user to a new screen-view 700 where a user can create new content. Displayed on the GUI are sections from each source of content 702 that could be categorised as “Music”, “Fashion”, “Art”, “Film & TV”, “Magazines”, “Venues”, “Geo-Location”, “Camera” or any other relevant category of digital assets.

The music section may show music tracks that can either be played or added to a playlist. The fashion section may contain sub-sections for: “Prints”, “Textures”, “Embellishments” and “Videos”. Tapping on top-level buttons on these pages may open a new selection of the related sub-category. These sub-categories show prints, textiles, embellishments and videos from leading designers, which can be purchased by tapping a “Purchase” button. Purchases can be processed through the app using a payment gateway such as “Sage Pay” or other.

Other sources of content can be geo-located using location information from the mobile device to pull digital assets from 3^{rd} party sources 406 such as Instagram or a service such as Tapastreet that pulls geo-related content from other sources of digital assets. 3^{rd} party sources are managed in the cloud 401 where at least one application may manage the integration of these assets with native assets in the system. The user can submit location data in advance for a place they will be visiting by searching by location. GPS can also be used to locate venues near the user that they may be attending, for example for a music festival or event. In some circumstances venues can provide custom content for events that would be stored in the arena database 404, for example: an O2 arena may provide unique content for the band performing on a particular night. A user can find smaller one-off events by searching for local venues.

Once the user has selected the content they want and press “Next” 705 they will be taken to the selection screen-view. The selected content is shown in a grid on the screen-view 802 and tapping them can preview the animations. Once the selection is finished, pressing “Next” 805 the user will proceed to the next screen-view.

An additional “Effects” screen-view is not illustrated but may allow the user to customize their content. A preview is shown and effects & filters can be applied. The effects can be randomized or further effects added like brightness, contrast or other. A slider or other GUI feature may control the speed of the animation, and the default speed will match fundamental frequencies in the songs selected. When the settings are complete the user can proceed by pressing “done”.

Before loading onto the jacket, the video can be reviewed 902 and edited if required. The app allows the user to select the garment(s) that they wish to update with the playlists generated on the previous screen-view. Connected apparel is shown 903 and when ready the user is able to proceed to synchronization by pressing next 906.

When the app proceeds to synchronization 1000 a simulation of the updated garment is shown 1002. Once synchronization is complete it notifies the user and proceeds with the next apparel item to be updated or returns to the previous screen-view.

The firmware on the MCU in the controller can be updated via Device Firmware Upgrade (DFU) over Bluetooth from the paired smartphone. If an upgrade is available then the cloud notifies the app and the upgrade is downloaded to the smartphone. When the display jacket in this example next connects to the smartphone then the DFU procedure is initiated. DFU firmware running on the MCU in the controller allows firmware upgrades to be installed over the Bluetooth connection with the smartphone and in this way enables the firmware in the controller to be kept up to date.

In the embodiment described above the user can listen to music through headphones connected to a smartphone running the app. The app is able to direct music to the headphones and simultaneously send trigger messages to the jacket to animate in time with the current music via a wireless method such as Bluetooth. The trigger messages contain information about which digital content the MCU should use to create animation instructions for the display and any specific variables for that particular instruction. In some cases there may be a trigger variable in the instruction used to simplify the triggering process.

An algorithm within the app is able to extract information about the music being played and this can be used to trigger the animations. Software that can extract data such as tempo or frequency ranges is well understood by masters of the art. A slight modification of this embodiment sees the music being played from a 3^{rd} party app. In this case, and if supported, the app will access information through the 3^{rd} party application through it's API. By accessing information about the track being played through the API the app will be able to determine when to send the triggers to the jacket and thereby synchronise the effects. Extra information about a particular track or 3rd party source may be held in the cloud as previously described and any specific digital content for the particular track can be uploaded to the memory through a wireless or other communication method.

In another example involving the embodiment of the display jacket described previously, the user is in a personal arena and wishes to select an animation which links the output of the jacket to a live signal. In this case the signal is a stream of biometric data such as a heartbeat from a music artist but it could by any other type of live signal.

An app running on a smartphone is able to send messages to the controller via a wireless connection method such as Bluetooth also as described previously. Messages sent to the garment by the app contain information about the desired digital content to be used and any other variables that can be used to define instructions for the display driver and haptic feedback device, in this case a vibration module. The app is able to receive information about the music artist's heartbeat from a remote server or other method and translates this information into a message that is sent to the controller. The message is translated into an instruction to the display driver and vibration motor controller by the MCU with parameters that are related to the information about the heartbeat. It should be clear to a master of the art that by this method the heat-beat of a music artist can be observed and felt through the jacket embodied in this example. And furthermore this example is not limited to a jacket but may be any other type of apparel or accessory including but not limited to: necklaces, hats, t-shirts, wristbands, shoes, headbands etc.

In a further evolution of the previous embodiment of the display jacket, the controller has an accelerometer whose output is used by the MCU as a parameter in creating the instructions for the display and, if present, the haptic. The accelerometer data can also, or alternatively, be transmitted to the paired smart device and subsequently stored in the cloud architecture. The accelerometer in this example can be replaced with any other type of sensor or combination of sensors including but not limited to: temperature, sound, orientation, pollution etc.

In another example involving the embodiment of the display jacket described previously, the user enters a retail arena of use. In this example an arena beacon operated by a high street retail chain will broadcast an RF message to all receiver devices in range 319. If the radio transceiver on the controller of the jacket successfully reads the message and the retailer has authorization from the user to engage further, as determined by interrogating the preferences information 504 in the user account 502, then the controller replies with the unique identification information of the user. If the Arena beacon receives the identification information successfully it will contact the cloud through a physical or wireless network connection 410 that is connected to the Internet. Processing in the cloud by at least one application 405 may allow the retail chain to suggest the correct configuration of the jacket to enable it to be controlled by radio transmitting hardware inside the store and also give access to digital assets (such as digital content) owned by the retail outlet. The retailer may also push messages directly to the user if their personal preferences allow. These messages could appear on the app or through another means such as email, text or a social media platform.

An arena beacon (beacon) 1100 consists of a printed circuit board (PCB) 1101 with at least one microcontroller 1102. The beacon has a number of wireless communication functionalities and may have some or all of Bluetooth 1112, Wi-Fi 1111, ZigBee 1110, IEEE802.11 1109, ultra sound 1108, Infrared (IR) 1107, audible sound or other wireless communication methods. The Beacon is able to communicate with enabled devices and pass messages to a server device (server) 321 via a wired or wireless network method such as Wi-Fi or Ethernet 322. The server can in turn pass messages back to the beacon to be broadcast to individual or all enabled garments. The server is a computing platform that is able to connect and communicate with the cloud via the Internet 323 and manages data flow between the beacons and the cloud in order to scale the implementation of a system in various arenas.

The RF message that is broadcast by the beacon 319 contains information including the identity of the Retailer. If this message is detected by the RF transceiver in the controller inside the jacket 312 then the jacket will pass on the details to the connected smartphone via Bluetooth 309 or Wi-Fi 310 that will in turn send a query to the cloud 314, 313. The cloud will search and process preferences set by the user and use this information to formulate a reply to the jacket controller via the smart device. The information in the reply may be authorization for the retailer to send further instructions or alternatively to ignore any further interaction. In the case of no authorization being given for further engagement with the retailer, the jacket will simply not reply to the message broadcast by the beacon. In the alternate case of authorization being given then the jacket controller replies to the beacon message with the ID of the user and other information such as Received Signal Strength Indication (RSSI).

An application in the cloud will process the data following the receipt of a return message from the jacket and this will determine if the Retailer owns data connected to the user. Data may include previous purchases or third party data with other metrics such as favourite music or any other information connected directly to the user. In the case of no data the cloud may send an instruction for a welcome message via the app and ask the user to provide personal information and to agree to any terms and conditions of operation in the particular retail arena. The user can decline and therefore not receive any further communication. If the user agrees then they will be granted access to digital assets specific to the Retailer. Instructions detailing the correct configuration of hardware in the jacket will be sent via the beacon and will allow the Jacket to download digital assets such as digital content for the display, software, music and others through a Wi-Fi connection. In addition there may be additional messages sent from the beacon to trigger animations on the jacket synchronized to the music being played in the retail space, as has been described previously.

The Arena of use in this example may be the physical interior of the Retailer's space but may cover other areas connected to the Retailer. Other spaces could include but are not limited to: the outside area of the Retailer's space, promotional stands, advertisements and partner retailers. The retailer in this particular example could be a fashion retailer, super market, restaurant, merchandise stool at a live performance or any other type of retailer.

To reinforce the description of the invention an embodiment of the invention can be described by using the example of a fibre optic dress. The user is wearing the dress in the personal arena and wishes to select a colour scheme and pattern from a well-known designer or brand. The dress has a controller which is able to create patterns and change colour in the fibres by way of at least one LED but most likely several, as described previously. The LED(s) can be single colour but will most likely be RGB LED capable of recreating any colour. The controller has a least 1 wireless communication method such as Bluetooth. An app running on a smartphone is able to send messages to the controller via a wireless connection method such as Bluetooth also as described previously.

An app has a GUI 602 that allows a user to configure the behaviour of an enabled garment such as the dress described in this embodiment. The app is operated by the wearer of the dress who can use it to select colours and patterns. The app works across a range of mobile devices meaning that the user can use a tablet, smartphone or smart watch to change the behaviour and appearance of the dress. Messages sent to the garment by the app contain information about the desired digital content to be used and any other variables that can be used to define instructions for the display driver, in this case a multiple output LED driver.

Further embodiments follow the above description but the apparel may be any type of apparel or accessory such as but not limited to baseball caps or headgear, bags, t-shirts, dresses, shoes or jackets.

An embodiment of the invention can be described by using the example of a display garment such as a baseball cap (cap) with an integrated OLED display where the cap and user are entering an entertainment arena from another such as a personal arena. As the user enters the stadium, communication occurs between the cap and one or more beacons, as described previously. If the credentials of the user are correct then the operational settings of the cap are changed to suit the stadium. The entertainment arena in this particular description could be a stadium where a performance by a musical artist is taking place but could also be promotional sites such as the area around a billboard, a remote viewing site with a screen to enable fans to watch the performance live or any other space that can be linked to the performance. During the performance the cap animates in time with the music and may synchronise with other elements of the performance such as the lighting, on stage display and special effects. It should be accepted by an expert in the art that a trigger signal could be sent to the cap by RF from a beacon to enable synchronisation. At certain points in the performance all enabled apparel present in the stadium are controlled in a way that renders them as pixels in a visual display covering the whole audience.

Communication between the cap and the beacons is the same as described in the previous embodiment. The correct credentials of the user will comprise a number of factors including privacy settings and other user preferences but may also include and not be limited to purchasing records of tickets to the performance, previous purchases of other related products or services and many others.

If the user has the correct credentials linked to their account and they have allowed the stadium server make changes to the hardware configuration of the cap, then RF and IR will be prioritised as communication methods in line with the preferred wireless control methods for scenarios with a potential for a high density of users.

For the enabled apparel to behave as individual pixels in an arena-wide display comprising of all connected enabled devices, the individual items of apparel must be configured with location data. There are 2 approaches to achieve this.

In one method 1200 a message is sent to all devices by RF which places them in a mode in which the IR and RF is prioritised. In order for the devices to determine where they are in 3D space, a directional IR source such as an IR laser is used in conjunction with synchronised radio messages broadcast to all devices 1201. The radio message is broadcast to all devices and contains the locational information related to the position of the IR source at that particular time. Through this process all enabled garments that have successfully detected the IR source and the RF message are calibrated and have locational data. A follow up message prepares the devices for content messages that contain locational coordinates along with information on animation or output behaviour. It is possible that a check of the number of devices that have received location data is carried out by sending a message to all devices and requesting a reply from all IDs that have been configured. If this is below a threshold then the process can be repeated. Over a threshold it is possible for devices to infer their location from the received signal strength indicator (RSSI) data in messages from surrounding devices: if a device does not have locational information after the maximum number of attempts 1203 then it can copy the information from the nearest device which has successfully inferred where it is by sending a request message 1204.

In another method all wearable devices are placed into an alternative calibration mode where they listen to broadcasts from other wearable devices. By including received signal strength indicator (RSSI) data in a message it is possible to propagate messages through a crowd 1302-1305 where part of such a message is an instruction to pass the message on to devices that are within a certain range. The outcome of such a protocol will be an annular propagation of the message through a crowd 1300. If the message is modified at each step and a time-code added which gives information about the time taken for a message to reach a particular device (or a count of the number of ‘hops’), then it will be clear to an expert of the art that the distance from the first message could be determined. Further to this if 3 messages were sent from known locations 1400 in a space then the relative location of a device 1404 in that space could be determined by the process of triangulation. Further to this it is also possible to determine the location of a device in 3D space using more reference messages from know locations. Experts in the art may use the theory behind GPS location as an analogy however the difference in this embodiment is that the delay data is carried with the message and not inferred by comparison with the current time code however this method could be adopted with the invention described.

In a preferred embodiment of the invention a musical artist uses an interactive wristband 1500 to create an engaging experience for an audience (users) as part of a performance. A number of wrist-mounted devices 1501 would used to measure the fans' Electro Dermal Reaction EDR in real time and use this data to control animations projected onto screens on the stage thereby illustrating the effect of the performance on the fans' emotional response. In addition the bands could be controlled to flash in time with the beat of the music and change colour in unison. Another option would be for the LED 1504 to give the fans' a representation of their EDR through the colour of the LED.

The wrist-mounted device 1501 consists of a circuit 2000, battery and casing. There are 2 metal contacts 1502 that are connected to the circuit that supports a number of electrical components on a Printed Circuit Board (PCB) 2004. The PCB circuitry is made up of a transceiver 2003, a sensor module 2005 that would preferably include an EDR sensor and an output method such as an LED or vibrator 2001, 2007.

The wrist-mounted devices 1600 would be handed out, left on seats, posted to users or any number of other means of distribution. When the user receives the device they are prompted to pull out a tag that is creating a short circuit between the battery and the rest of the electronic circuit inside the device thereby ensuring the device is not powered and battery life maintained. By removing the tag the short circuit is removed and the device powers up.

When powered the LED or other output method can be controlled to indicate to the user that the device is operational 1702. The user places the device on either wrist with the sensor pads on the inner wrist 1600. The device is secured onto the wrist with a strap and fastened 1601. There may be a programme on the device that indicates a good fit 1704: by taking readings from the EDR sensor circuit, the point at which a steady reading within an acceptable range will be indicated by an animation of the LED such as a green pulse for 3 seconds or alternatively a vibration if the required hardware is included in the design.

Once operational the device will be able to send and receive data and commands wirelessly through its transceiver 2003. A wireless link such as Bluetooth, IEEE802.11, ultra sound, Infra red (IR) or any other electrical/electromagnetic method may be used. In the preferred embodiment a radio solution such as STM32 W by ST Microelectronics is utilised to handle wireless communication by radio at 2.4 GHz with the IEEE 802.15.4 specification. This radio specification ensures that there is little or no interference from mobile phones in the arena of use.

Communication can happen between the bands, for example message hopping as has been described in a previous example that can allow the bands to infer their location by calculating their distance from a band (or transmitter) at a known location. Message hopping can also be used to create visual effects such as LED patterns radiating away from an incident ‘seed’ band. By altering the animation settings designed into the firmware it should be clear to see how numerous geometric patterns could be achieved by controlling the LED behaviour in relation to messages containing RSSI information propagated through a crowd.

Another mode of communication is with a network of arena beacons located in the arena of use. The location of the beacons is specified to ensure that the whole of the arena of use is reachable by the wireless method.

An embodiment of an arena beacon 1802 consists of a radio transceiver unit 1803, an embedded computing platform 1804, an Ethernet switch 1805 and a power supply. The bands will transmit their unique identification number followed by sensor data 1706. In one example the data sent may be a measurement of EDR. Once the data is received by any of the beacons it is translated into a serial message. In an application of less than 200 wearable devices the messages from a single beacon can be fed to a processing computer via a standard USB connection and stored or used. In an application of more than 200 wearable devices the serial message will be fed to an embedded computing platform 1804 such as Raspberry Pi, Beagle board or other where it is translated into a User Datagram Protocol (UDP) message directed at a server device 1809. Alternatively the UDP message can be directed to a nearby beacon and the message stream networked through a beacon Network 1806 on which the server is located.

The server device will listen for messages on the beacon Ethernet network and update a buffer database with the wearable device ID and EDR data with a time code. It is possible that a transmission from a wearable device is received multiple times and therefore the server program will either overwrite or skip identical records. Unique records will be stored in a final database. Additional processing is carried out by the server to isolate usable information from the EDR data. Database software such as Oracle or Apache may be used however any number of other database solutions may also be used. The data in the final database can be used in real-time at the event 1900 or any time after.

Access is granted to selected information through an Auxiliary Program Interface (API). In the preferred embodiment a Restful (REST) API allows access through a secure network. Through the API external hardware such as media servers 1905 can access stored data on the database and process this to create instructions for further hardware such as a video controller 1906, sound controller 1907 or another media server.

Transmission back to the wearable devices enables instructions to be sent to the micro controller unit (MCU) 2002 within said devices. These messages can be used to change the behaviour of the bands, such as the type of data being sent or sample rates of sensor data, or can be used to change the outputs on the device such as the colour and animation of an LED or the vibration of a vibrator module. To transmit instructions a serial message must be sent to the radio transceiver in the beacon. This can either be done directly by connecting a computer via USB and running a program that can access serial ports and send messages. Alternatively a UDP message can be sent to the embedded computing platform in the hub and the message translated into serial that is then sent to the radio transceiver and transmitted to the wearable devices. In the latter example a UDP message could come from anywhere on the beacon Ethernet network.

An option would be for certain instructions to be orchestrated by the server program. For example, if the EDR sensor transmitted from a particular device hits a certain level, then the LED on that device can be sent an instruction to flash, thereby notifying the user of a certain level of emotional response. Alternatively a computer or media server on secure network can request the API to send instructions in line with the performance elements. An example would be changing the colour of the LED to match the lighting scheme or pulsing the LED in time with the music.

Transmission to the wearable devices can be global or individual. If an individual wearable device needs to be controlled then its ID is included in the serial message. In this embodiment of the invention an example of the structure of a serial message is given:

[start-delimiter][address:<unique id>(<broadcast>][colour(3 values)][pattern-type][end-delimiter]

Here a unique ID can be chosen. An ID of 0 will broadcast to all devices. Colour values will define the LED colour based on standard red, green and blue values. Pattern type defines the animation. There is also the option of sending instructions for local control of the LED with the MCU defining the colour of the LED, for example the colour of the LED could be related to the first differential of EDR over time to give an indication of the rate of change of EDR.

In a development of the above embodiment the audience is invited to access a user account 502. By accessing the cloud 400 described in previous examples either through a web portal or though an app, users may input personal information 505, preferences 504 and digital assets 506 including but not limited to images, videos and music. In the time leading up to the performance, organisers can communicate with the users through a plurality of means such as email, text, social media or a proprietary message service in the app described previously. Before the performance a number of wristbands are distributed as described previously but in addition users are asked to register a unique ID printed on the wristband either through a web portal, app or a kiosk at the event. The unique ID could be textural or it is also possible to utilise a QR code that can be scanned using a smartphone running a suitable app. The registration process links the unique ID of the wristband to the user and this information is stored in the cloud.

When the wristband is activated as described above and the server retrieves data, data records are published to the remote server and cloud via an Internet connection. A software application in the cloud 405 distributes the EDR data to its relevant user account 403, 502 by inspecting the unique ID transmitted with the EDR data. It is possible at this point for a second application running on the cloud 405 to analyse the data and send back messages to the sever in the arena of use 410 that could include animation instructions for the LED wristbands. Further to this example the EDR data and processed data can be made available through an API and accessible by 3^{rd} party services 406.

After the performance users are able to log into their user accounts and see their data. In an embodiment users will be able to play video footage of the performance and opt to view data streams augmented onto the video. Data streams could be the user's own or selected persons such as band members of celebrities who were also at the performance. In an even further development of the above example, a number of performances are occurring simultaneously around the world. Each performance has an audience with wristbands reading EDR and posting this to a cloud. As the cloud is de-localised it is possible for the geographically separate performances to be linked. For example the average EDR data from one performance can be used to drive the lighting effects of the other performance being held in a different country.

In another embodiment of the invention a wrist-mounted device is used to measure one, some or all of physiological, physical and environmental levels and to transmit this directly to a computing device using a wireless communications method. The transmitted data is used to enhance the user experience of a software program on a computing device. Instructions can be transmitted back to the wrist-mounted device to control outputs built into said device.

A common wireless communication protocol such as Bluetooth is used to transmit data from the wristband to a computing device. The computing device may be a smart phone, tablet computer or any other computing platform with a visual user interface. A software program such as an app or web app uses the data to affect aspects of the program such as, but not limited to visual animations, audio effects and communications. The software program may be or be linked to a web based platform such as a social media website or other such as a music playback website, an image website, an online retailer or any other type of website. Instructions can be transmitted back to the wrist-mounted device by the software program either directly or via a third party such as said website. The outputs on the wrist-mounted device can include but are not limited to LED(s), Organic LED display, vibrator, speaker or other output method.

The wrist-mounted device measures physiological data from the body and may also take readings of some, all or none of acceleration, temperature, light intensity and sound intensity. The sensor data is processed before being transmitted by the method described previously. The data transmitted may be stored on a database on a remote server where it may also be processed further to the processing by the MCU on the circuitry of the wrist-mounted device. The database may be part of a cloud-based architecture as described in previous examples.

In another embodiment of the invention a physiological sensing device is used to measure physiological data from the body and said data is communicated by a wired connection to a computing device. The wired connection also provides the electrical power to the sensor circuitry. The transmitted data is used to enhance the user experience of a software program on a computing device.

The device consists of an electrical circuit containing a low power MCU, sensor circuitry, a DC rectification circuit with voltage regulation and smoothing, a 3.5 mm phone connector, conductive surfaces and a body. The 3.5 mm phone connector may be a 3 channel TRS or 4 channel TRRS type. The conductive surfaces are made from a conducting metal, fabric, ink or any other conductive material. The body is made from a resistant material, paper or fabric/textile.

Power is provided to the device by way of one of the audio output channels on a computing device such as a smartphone, tablet computer or any computing device including which can include embedded computing platforms. A waveform with a frequency of 20 kHz may be synthesized by a software program on the computing device to transmit power however a number of different frequencies can be used. A rectifying circuit transforms the waveform into a steady DC current by way of a number of discrete electrical components including but not limited to diodes and capacitors. Once the threshold electrical conditions are achieved to enable the MCU to power up and operate, the MCU reads the sensor data from the sensor circuitry and may process this before transmitting back to the computing device using the microphone channel on the audio socket of said device.

The sensor circuitry measures one or a combination of EDR, temperature, pulse oximetry and surface temperature and where appropriate the sensor contacts are comprised of said conductive material. The sensor contacts can be placed at a number of positions on the body to read physiological data including fingers, palm, wrist, neck, torso, legs, arms and any other part of the body. In this embodiment it is preferred that EDR is measured from the fingers, hand or wrist.

In another embodiment of the invention an electronic clothing label can be attached to an item of apparel such as a T-shirt, baseball cap, shoes or any other item. An app running on a smartphone can identify the item of apparel, calculate how far away it is at any point and therefore infer if the item is being worn by the user, and furthermore allow actions to be carried out as a result of said item being detected and identified.

The label consists of a PCB with at least one microcontroller, a battery and an antenna. Firmware on the microcontroller is able to transmit messages from the label. In the preferred embodiment the messages follow the iBeacon protocol and therefore the label transmits a unique ID and RSSI value to nearby devices.

When a message is received by the smartphone, the app sends a query to the cloud to check if the ID is linked to the user account of the user. Furthermore by evaluating the RSSI data over time it is possible to determine if the label is moving in relation to the user. If the ID is registered in the cloud then the user account is notified that the user is wearing the specific T-shirt. With this information it is possible to enable actions such as notification to other users that the T-Shirt is being worn. Alternative actions can be instigated by the cloud depending on a number of factors such as the user's current activity, location or any other combination possible with the examples given so far. In the case of the label ID not being associated to the user, a message may be sent by the cloud to the user. An example of where this may happen can be given by considering the scenario of an apparel retail outlet where items with the labels described here are on a clothes rail. By identifying that the ID's detected are not already associated to other users the cloud can deduce that they are available for purchase and therefore offer the user information about the item. Further to this and depending on the preferences set by the user, the retail outlet may send any type of digital notification or asset to the user.

In a modification of the previous embodiment, the label can be designed into a badge that can be attached to an number of items including but not limited to apparel

In another embodiment of the invention, sensor and wireless communications circuitry and outputs are built into apparel such as items of clothing and accessories. Electrical circuitry is integrated into garments and accessories to measure one, some or all of physiological, physical and environmental levels in real time and use this data to control elements of a live performance such as a film or other or used to enhance the user experience of a software program on a computing device. Instructions can be transmitted back to the device to control outputs built into said device that could include, but is not limited to LEDs, vibrators and speakers.

In this embodiment the apparel could include trousers, skirts, shirts, jackets, shoes, headphones, watched, glasses and any other apparel.

A further embodiment of the invention can be described by using the example of an item of jewelry such as a Bracelet but could be any of Headphones, Bags (clutch and rucksacks), shoes, sneakers, jackets, caps, hats, jeans, badges, t-shirts, trousers, shirts, gilets, dresses, skirts, jumpers, sweatshirts, belts

The bracelet has a physiological sensor and an LED display. When the user is in a social arena the operational settings on the device changes to suit direct communication between it and other bracelets, LED Jackets, headphones, shoes or any item of enabled apparel described in this document or otherwise.

The bracelet consists of a controller, a battery and a body. The controller in the bracelet consists of a printed circuit board (PCB) with at least one microcontroller and an electronic memory device such as flash. The controller has a number of wireless communication functionalities and may have some or all of Bluetooth, WiFi, ZigBee, IEEE802.11, ultra sound, Infrared (IR) or audible sound. The controller also contains circuitry to enable the bracelet to measure some or all of physiological, physical and environmental levels. The battery in the Bracelet is rechargeable but in some instances may be replaceable.

The bracelet is paired to a Smartphone device or other that is capable of detecting the users location through GPS, WiFi or other method.

For the purpose of this example the social arena is a bar where a number of enabled devices are present and the user is moving from the personal arena into the social arena.

The transition of from the Personal Arena to the Social Arena can be detected by using the GPS capability of the smartphone with which it is paired however it could also be derived though Cell-ID, Wi-Fi or one of the other methods described previously. In the case of GPS being used to detect the transition between arenas the location of the user is relayed to the cloud. An application running in the cloud is able to compare the current position of the user with a database of social arenas which in turn is derived using 3^{rd} party mapping services such as Google Maps but can also be defined by the user though the app described in previous examples.

When in the social arena the RF messages are transmitted with the unique user ID as described in previous examples. If the device or any other enabled apparel item receives a message from another broadcasting device (other device) it sends a query to the cloud via the connected smartphone.

The ID of the other device is evaluated against a list of ‘friendly’ IDs and if the search results are positive, in that the received ID is a ‘friend’, then the bracelet is instructed to reply with an RF message containing an invite to engage.

Friendly IDs can be set by the user through the app described in the previous examples but may also be derived from 3^{rd} party sources such as social media platforms, email contact's lists or any other source of digital identification.

In the event of the Other Device not being considered friendly, then an invite can be sent to establish friend status. This option will be controlled by the preferences set by the user through the App and stored in the cloud described in detail in previous examples.

Once connected the bracelet may communicate to the friendly devices in a number of ways including but not limited to sending visual information that can be displayed on enabled apparel with display functionality, send emotional state data or trigger any of the output functions of said enabled apparel. In the same way friendly devices can push instructions to the bracelet.

A further embodiment of the invention can be described by using the example of display nails that are worn on the hand of a user and display visual content from various sources.

The display nails comprise of a visual display, a controller and a battery. The visual display could be an LED matrix, an OLED display or any other display technology. The controller consists of at least one microcontroller. The display, controller and battery can be built into a single unit but can also be distributed and built into auxiliary devices that are worn as accessories. The auxiliary devices worn as accessories can be rings, bracelets, watches or any other item of apparel.

The content outputted onto the display nails can be stored locally on an embedded storage device such as a flash integrated circuit (IC) or be streamed from a connected mobile device. In the case of a mobile device being used as a source for the content an App as described earlier enables users to select visual content from a number of sources such as but not limited to: purchased animations, social media channels and geo-located images.

1. A system for transferring data between a wearable item and a server to allow said wearable item to perform a specific task at an output the system comprising: one or more wearable items each item having an integrated controller, said controller having an output and a communication device, for sending messages to and receiving messages from a server.

2. A system according to claim 1 wherein the communication device is a wireless communication device.

3. A system according to claim 1 wherein the server is in the same geographic location as the wearable item.

4. A system according to claim 1 wherein the server is a remote server.

5. A system according to claim 1 wherein the server is a mobile computing device such as a smart phone.

6. The system according to claim 5 wherein the mobile computing device communicates with a server.

7. A system according to claim 1 wherein data stored by said server includes digital assets such as photographs, videos, music, text, books, physiological data, user data, and user preferences.

8. The system for transferring data according to claim 1 wherein the server has a cloud computing architecture.

9. The system according to claim 7 wherein the cloud computing architecture has at least one database, at least one software application and can be accessed through an internet connection.

10. The system according to claim 8 wherein the database has at least one user account.

11. The system according to claim 1 in which the wearable items include garments, accessories and objects with at least one form of visual and/or tactile output.

12. The system according to claim 1 in which the output includes at least one form of visual and/or tactile output.

13. The system according to claim 1 in which a wearable item includes garments, accessories and objects that monitor physiological and/or other data from users.

14. The system according to claim 5 wherein the mobile computing device has a software application that is connected to at least one server.

15. The system according to claim 13 in which the software application has a graphical user interface (GUI).

16. The system according to claim 1 wherein data is transferred within the physical domain.

17. The system according to claim 1 wherein the data is transferred beyond the physical domain, crossing over geographic boundaries.

18. The system according to claim 1 wherein said wearable item is a wrist worn device.

19. The system according to claim 1 wherein relative location can be determined by analyzing received signal strength from different wearable items.

20. The system according to claim 18 wherein the distance between items can de be determined by the number of messages sent between said devices.

21. The system according to claim 1 wherein the wearable item is a clothes label able to communicate with said mobile computing device.

22. The system according to claim 3 wherein the data is accessible through an API.
